(19) United States
(12) Patent Application Publication
(10) Pub. No.: US 2014/0310548 A1
(43) Pub. Date: Oct. 16, 2014

(54) ELECTRONIC DEVICE AND METHOD FOR POWER MANAGEMENT

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: MING-TSUNG CHEN, New Taipei (TW); MING-FENG TSAI, New Taipei (TW); YA-JUN ZHAO, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/249,368

(22) Filed: Apr. 10, 2014

(30) Foreign Application Priority Data
Apr. 11, 2013 (CN) 2013101245016

(51) Int. Cl. G06F 1/32

(52) U.S. Cl. CPC G06F 1/3225
USPC 713/321

(57) ABSTRACT

In a method for managing power of slave electronic devices using a master electronic device, the slave electronic devices are connected in sequence and an end one of the slave electronic devices is connected to the master electronic device. Each of the slave electronic devices determines and transmits their charging priority information to the master electronic device. The master electronic device determines a charging sequence of the slave electronic devices, determines a target one of the slave electronic devices according to the charging sequence, and sends a charging signal to the connected slave electronic devices, to charge the target one of the slave electronic devices.

### BACKGROUND

1. Technical Field

The present disclosure relates to power management technology, and particularly to an electronic device and a method for managing power of slave electronic devices using a master electronic device.

2. Description of Related Art

When multiple electronic devices are in use, users usually need to continually check how much residual electrical capacity each electronic device has, and need to charge the electronic device which has low electrical capacity. However, it is tedious and inconvenient for users to do this. To solve these problems, each electronic device can be connected to a socket to get being charged all the time. However, it will increase cost to use these sockets, in addition, it's difficult to manage these multiple electronic devices with each of them being connected to a socket.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic diagram of one embodiment for connections among electronic devices, which include a master electronic device and slave electronic devices.

FIG. 2 is a block diagram of each of the electronic devices of FIG. 1.

FIG. 3 is a schematic diagram of a table of parameters.

FIG. 4 is a schematic diagram illustrating the charging priorities of the slave electronic devices of FIG. 1.

### DETAILED DESCRIPTION

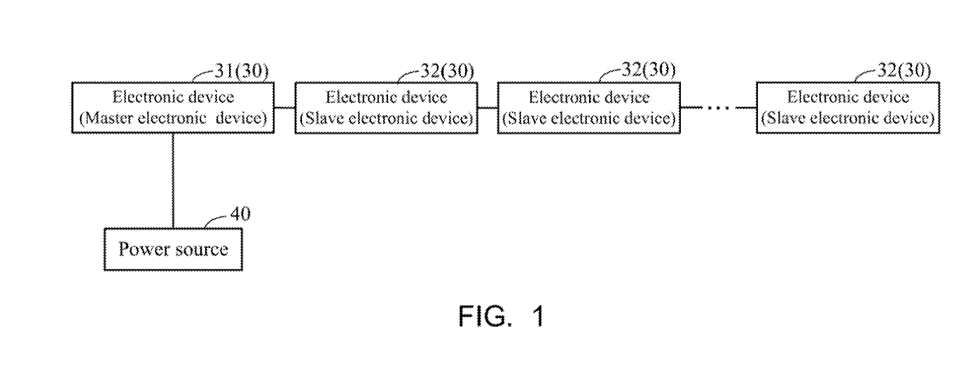

FIG. 1 is a schematic diagram of one embodiment for connections among electronic devices 30, which includes a master electronic device 31 and slave electronic devices 32. The slave electronic devices 32 are connected in sequence and an end one of the slave electronic devices 32 is connected to the master electronic device 31. The master electronic device 31 is connected to a power source 40 to obtain electrical capacity from the power source 40 to charge the slave electronic devices 32.

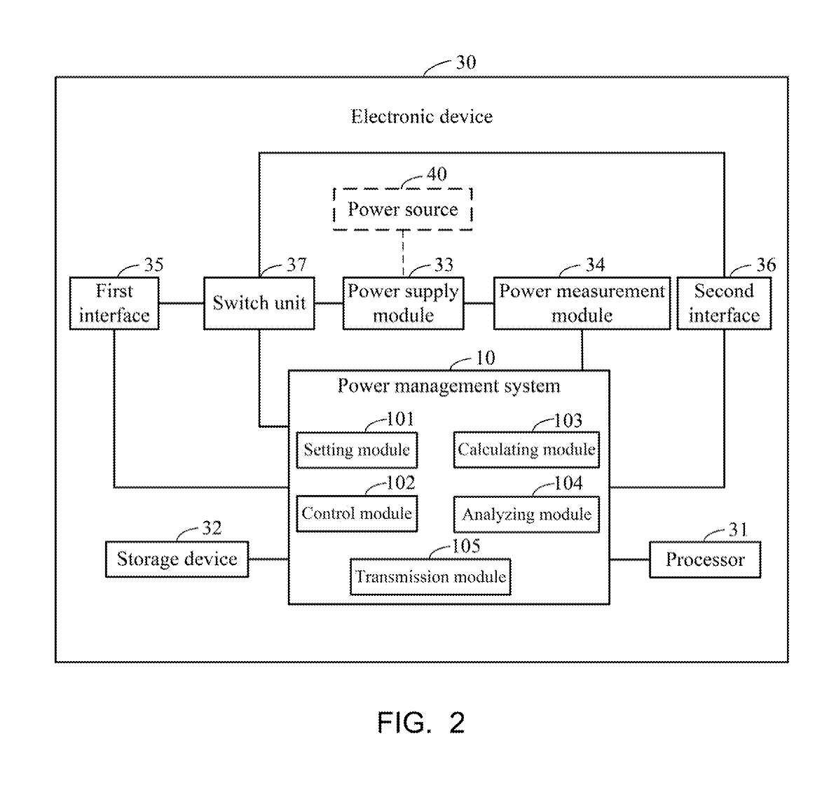

FIG. 2 shows functional blocks in each electronic device 30 according to one embodiment. A power management system 10 may be included in each of the electronic devices 30, as well as included in both of the master electronic device 31 and the slave electronic devices 32. The power management system 10 is used to determine charging priority information of each of the slave electronic devices 32, and transmit the charging priority information to the master electronic device 31 to determine a charging sequence of the slave electronic devices. By utilizing the power management system 10, the slave electronic devices 32 may be charged by the master electronic device 31 in a variable sequence.

Each of the electronic devices 30 includes at least one processor 31 and a storage device 32. The at least one processor 31 is used to executed the power management system 10 and other applications, such as an operating system, installed in the electronic devices 30. The storage device 32 stores one or more programs, such as the operating system and applications of the electronic device 30. The storage device 32 can be a storage card, such as a memory stick, a smart media card, a compact flash card, a secure digital card, or any other type of memory storage device.

The power management system 10 may include computerized instructions in the form of one or more programs that are executed by the at least one processor 31 and stored in one or more of the storage devices 32. In one embodiment, the power management system 10 includes one or more modules, for example, a setting module 101, a control module 102, a calculating module 103, an analyzing module 104, and a transmission module 105. In general, the word “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

Each of the electronic devices 30 further includes a power supply module X, the power supply module 33 stores electrical capacity and supplies power for the electronic device 30. In some embodiments, the power supply module 33 is able to obtain electrical capacity from the power source 40. The setting module 101 in each of the electronic devices 30 determines a role of each of the electronic devices 30 to be a master electronic device or a slave electronic device. In one embodiment, the setting module 101 determines the current electronic device 30 to be a master electronic device if the power supply module 33 of the current electronic device 30 is connected to the power source 40, or determines the current electronic device 30 to be a slave electronic device if the power supply module 33 is not connected to the power source 40. In other embodiments, the electronic device 30 is manually set by user to be a master electronic device or a slave electronic device.

Each of the electronic devices 30 further includes a power measurement module 34 connected to the power supply module 33. The control module 102 in each of the slave electronic devices 32 controls the power measurement module 34 to measure a residual electrical capacity of the power supply module 33 of each of the slave electronic devices 32.

The calculating module 103 in each of the slave electronic devices 32 calculates a ratio of the measured residual electrical capacity of each of the slave electronic devices 32, according to the measured residual electrical capacity and a saturated electrical capacity of the power supply module 33 of each of the slave electronic devices 32.

The analyzing module 104 in each of the slave electronic devices 32 determines a first charging priority of each of the slave electronic devices 30 according to the calculated ratio.

In one embodiment, the storage device 32 of each slave electronic devices 32 further stores a table of parameters, each parameter includes a ratio of the residual electrical capacity and an associated first charging priority. The analyzing module 104 determines the first charging priority of each of the slave electronic devices 30 by querying the table to obtain the first charging priority associated with the calculated ratio.

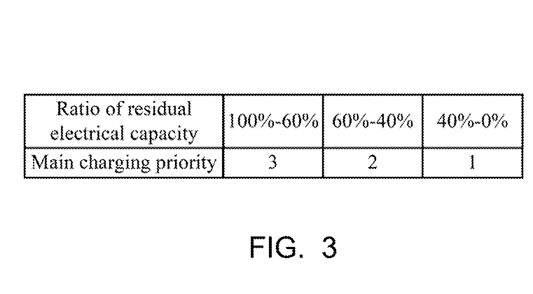

In one embodiment, as shown in FIG. 3, if the ratio of the residual electrical capacity falls within a range of 100%-60%, the associated first charging priority is predetermined to “3”. If the ratio of the residual electrical capacity falls within a range of 60%-40%, the associated first charging priority is predetermined to “2”. If the ratio of the residual electrical capacity falls within a range of 40%-0%, the associated first charging priority is predetermined to “1”.

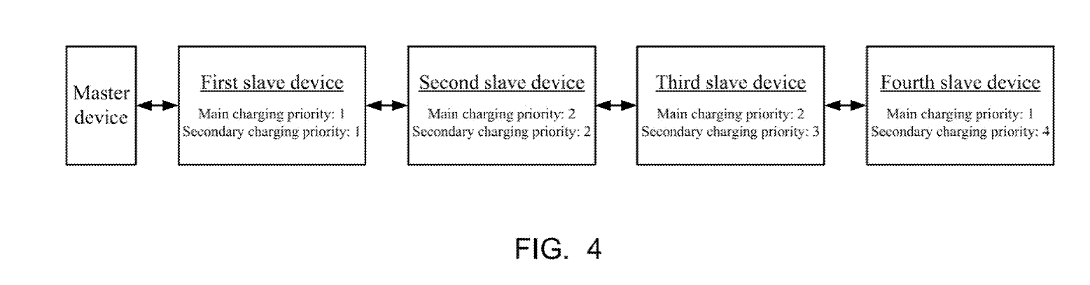

In one embodiment, the analyzing module 104 in each of the slave electronic devices 32 further determines a second charging priority of the slave electronic devices 32 according to the connection sequence of the slave electronic devices 32. For example, as shown in FIG. 4, four slave electronic devices are connected in sequence, and then are connected to the master electronic device. The second charging priority of the first slave electronic device is determined to be “1”, and the second charging priority of the fourth slave electronic device is determined to be “4”.

FIG. 2 as well shows that each electronic device 30 further includes a first interface 35 and a second interface 36. Each electronic device 30 communicates with a front connected one of the slave electronic devices 30 through the first interface 35, and communicates with a rear connected electronic device 30 through the second interface 36. “Front” described herein refers to a direction close to the master electronic device 31, and “rear” described herein refers to a direction far away from the master electronic device.

In one embodiment, each electronic device 30 is provided with a unique identification (UID) code so that other devices can uniquely identify each of the electronic devices 30.

The transmission module 105 in each of the slave electronic devices 32 transmits charging priority information of each of the slave electronic devices to the master electronic device 31.

In the illustrated embodiment, the other end one of the slave electronic devices 32 farthest away from the master electronic device 31 transmits its charging priority information to a front connected one of the slave electronic devices 32.

Each of the slave electronic devices 32 connected between two end ones of the slave electronic devices 32 receives charging priority information of one or more rear slave electronic devices 32 from a rear connected one of slave electronic devices 32. In addition, transmits charging priority information of a current electronic device 32 and the received charging priority information to a front connected one of the slave electronic devices 32.

The end slave electronic device 32 connected to the master electronic device 31 receives charging priority information of one or more rear slave electronic devices 32 from a rear connected one of slave electronic devices 32, and transmits its charging priority information and the received charging priority information to the master electronic device 31.

In one embodiment, the charging priority information includes a UID code, a first charging priority, and a second charging priority of each of the slave electronic devices 32.

The transmission module 105 in the master electronic device 31 receives charging priority information of the slave electronic devices 32 from the end slave electronic device 32. The analyzing module 104 in the master electronic device 31 determines a charging sequence of the connected slave electronic devices 32 according to the received charging priority information of the connected slave electronic devices 32.

In one embodiment, the analyzing module 104 in the master electronic device 31 determines the charging sequence according to the first charging priorities included in the received charging priority information. Or determines the charging sequence according to the second charging priorities included in the received charging priority information if two or more slave electronic devices having a same first charging priority.

For example, as shown in FIG. 4, both of the first and fourth slave electronic devices have a first charging priority “1”, and both of the second and the third slave electronic devices have a first charging priority “2”. So both of the first and fourth slave electronic devices will be charged before both of the second and the third slave electronic devices. In addition, the first slave electronic device has a second charging priority “1”, and the fourth slave electronic device has a second charging priority “4”, so the first slave electronic device will be charged before the fourth slave electronic device. The second slave electronic device has a second charging priority “2”, and the third slave electronic device has a second charging priority “3”, so the second slave electronic device will be charged before the third slave electronic device.

The analyzing module 104 in the master electronic device 31 determines a target one of the slave electronic devices 32 according to the charging sequence. The transmission module 105 in the master electronic device 31 sends a charging signal for charging the determined target one of the slave electronic devices 32 to the end slave electronic device 32.

In one embodiment, the charging signal includes an UID code of the target one of the slave electronic devices 32 according to the charging sequence.

The transmission module 105 in each of the slave electronic devices 32 receives the charging signal from the master electronic device 31, and the control module 102 in each of the slave electronic devices 32 charges the target one of the slave electronic devices 32.

FIG. 2 shows that each of the electronic devices 30 further includes a switch unit 37 connected between the first interface 35, and the power supply unit 305 and the second interface 36. The control module 102 in each of the slave electronic devices 32 controls the switch unit 37 to selectively connect the first interface 35 to the power supply unit 305 or connects the first interface 35 to the second interface 36.

In the illustrated embodiment, when the first interface 35 of each of the slave electronic devices 32 receives the charging signal, the control module 102 in each of the slave electronic devices 32 determines whether the UID code contained in the charging signal is the same as the UID code of the current slave electronic device 32. If the UID code included in the charging signal is the same as the UID code of the current slave electronic device 32, then the current electronic device 32 is the target one of the slave electronic devices 32. The control module 102 switches the switch unit 37 to connect the first interface 35 to the power supply module 33, to allow the power supply module 33 of the current electronic device 32 to be charged by the charging signal received from the first interface 35. Otherwise, if the UID code included in the charging signal is different from the UID code of the current slave electronic device, then the current electronic device 32 is not the target one of the slave electronic devices 32. The control module 102 switches the switch unit 37 to connect the first interface 35 to the second interface 36, to allow the charging signal to be transmitted to the one or more rear slave electronic devices 32 through the second interface 36, to charge the rear slave electronic devices 32.

Therefore, multiple electronic devices 30 can be connected together and be automatically charged in a charging sequence determined according to their charging priorities, with only the master electronic device being connected to the power source, which will greatly improve the power management efficiency.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A method for managing power of slave electronic devices using a master electronic device, the slave electronic devices being connected in sequence and an end one of the slave electronic devices being connected to the master electronic device, each of the slave electronic devices comprising a power measurement module, the method comprising:
controlling the power measurement module to measure a residual electrical capacity of each of the slave electronic devices;
calculating a ratio of the measured residual electrical capacity of each of the slave electronic device;
determining a first charging priority of each of the slave electronic devices according to the calculated ratio;
transmitting charging priority information of each of the slave electronic devices to the master electronic device, the charging priority information comprising the first charging priority of each of the slave electronic devices;
in response to receiving a charging signal for charging a target one of the slave electronic devices from the master electronic device, charging the target one of the slave electronic devices.

2. The method as described in claim 1, wherein the charging priority information further comprises a second charging priority of each of the slave electronic devices, and the second charging priority of each of the slave electronic devices is determined according to a connection sequence of the slave electronic devices.

3. The method as described in claim 2, wherein transmitting charging priority information of each of the slave electronic devices to the master electronic device comprises:
the other end slave electronic device farthest away from the master electronic device transmitting its charging priority information to a front connected one of the slave electronic devices;
each of the slave electronic devices connected between two end ones of the slave electronic devices receiving charging priority information of one or more rear slave electronic devices from a rear connected one of slave electronic devices, and transmitting charging priority information of a current slave electronic device and the received charging priority information to a front connected one of the slave electronic devices;
the end slave electronic device connected to the master electronic device receiving charging priority information of one or more rear slave electronic devices from a rear connected one of slave electronic devices, and transmitting its charging priority information and the received charging priority information to the master electronic device.

4. The method as described in claim 1, wherein in response to receiving a charging signal for charging a target one of the slave electronic devices from the master electronic device, charging the target one of the slave electronic devices comprises:
charging a current slave electronic device if the current slave electronic device is the target one of the slave electronic devices, or transmitting the charging signal to a rear connected one of slave electronic devices if the current slave electronic device is not the target one of the slave electronic devices.

5. A method for managing power of slave electronic devices using a master electronic device, the slave electronic devices being connected in sequence and an end one of the slave electronic devices being connected to the master electronic device, the method comprising:
in response to receiving charging priority information of the connected slave electronic devices from the end slave electronic device, determining a charging sequence of the slave electronic devices;
determining a target one of the slave electronic devices according to the charging sequence; and
sending a charging signal for charging the target one of the slave electronic devices to the connected slave electronic devices through the end slave electronic device.

6. The method as described in claim 5, wherein the charging sequence of the slave electronic devices is determined according to first charging priorities in the received charging priority information, or determined according to second charging priorities in the received charging priority information when two or more slave electronic devices having a same first charging priority.

7. An electronic device in serial connection to other electronic devices, the electronic device comprising:
a power measurement module;
at least one processor; and
a storage device storing a plurality of instructions, which when executed by the at least one processor, causes the at least one processor to:
determine a role of the electronic device to be a slave electronic device or a master electronic device;
when the electronic device is a slave electronic device and the other electronic devices comprise a master electronic device and slave electronic devices, control the power measurement module to measure a residual electrical capacity of the electronic device;
calculate a ratio of the measured residual electrical capacity of the electronic device;
determine a first charging priority of the electronic device according to the calculated ratio;
transmit charging priority information of each of the slave electronic devices to the master electronic device, the charging priority information comprising the first charging priority of each of the slave electronic devices;
in response to receiving a charging signal for charging a target one of the slave electronic devices from the master electronic device, charge the electronic device if the electronic device is the target one of the slave electronic devices, or transmit the charging signal to a rear connected one of slave electronic devices if the electronic device is not the target one of the slave electronic devices.

8. The electronic device described in claim 7, wherein the charging priority information further comprises a second charging priority of each of the slave electronic devices, the at least one processor of the electronic device further determines the second charging priority of the electronic device according to the connection sequence of the electronic device and the other electronic devices.

9. The electronic device as described in claim 8, wherein the at least one processor transmits charging priority information of each of the slave electronic devices to the master electronic device by:
transmitting the charging priority information of the electronic device to a front connected one of the slave electronic devices when the electronic device is an end one of the slave electronic devices farthest away from the master electronic device;
receiving charging priority information of one or more rear slave electronic devices from a rear connected one of slave electronic devices, and transmitting charging priority information of the electronic device and the received charging priority information to a front connected one of the slave electronic devices, when the electronic device is a slave electronic device connected between two end ones of the slave electronic devices;
receiving charging priority information of one or more rear slave electronic devices from a rear connected one of slave electronic devices, and transmitting the charging priority information of the electronic device and the received charging priority information to the master electronic device, when the electronic device is an end one of the slave electronic devices connected to the master electronic device.

10. The electronic device as described in claim 7, wherein when the electronic device is a master electronic device and the other electronic device are slave electronic devices, the at least one processor is further caused to:
in response to receiving charging priority information of the slave electronic devices from the end of the connected slave electronic devices, determine a charging sequence for the connected slave electronic devices;
determine a target one of the slave electronic devices according to the charging sequence; and
send a charging signal for charging the determined target one of the slave electronic devices to the connected slave electronic devices.

11. The electronic device as described in claim 10, wherein the at least one processor determines the charging sequence according to first charging priorities comprised in the received charging priority information, or determines the charging sequence according to second charging priorities comprised in the received charging priority information if two or more other similar electronic devices having a same first charging priority.

12. The electronic device as described in claim 7, wherein the at least one processor determines a role of the electronic device to be a slave electronic device or a master electronic device by:
determining the electronic device to be a master electronic device if the at least one processor determines that the electronic device is connected to a power source, or determining the electronic device to be a slave electronic device if the at least one processor determines that the electronic device is not connected to the power source.

13. The electronic device as described in claim 7, wherein the storage device further stores a table of parameters, each parameter comprising a ratio of the residual electrical capacity and an associated first charging priority, the at least one processor determines the first charging priority of the electronic device by querying the table to obtain the first charging priority associated with the calculated ratio.

14. The electronic device as described in claim 7, further comprises a first interface and a second interface, the electronic device communicates with a front connected one of the slave electronic devices through the first interface, and communicates with a rear connected electronic device through the second interface.

15. The electronic device as described in claim 14, further comprises a switch unit connected between the first interface, and the power supply unit and the second interface, wherein the at least one processor further controls the switch unit to selectively connect the first interface to the power supply unit if the electronic device is the target one of the slave electronic devices, or connect the first interface to the second interface if the electronic device is not the target one of the slave electronic devices.
